(19) United States
(12) Patent Application Publication
(10) Pub. No.: US 2026/0218488 A1
(43) Pub. Date: Jul. 30, 2026

(54) Electric Excavator With Power Store Housing

(71) Applicant: Caterpillar SARL, Geneva (CH)

(72) Inventor: Steven Gahlings, Cambridge (GB)

(21) Appl. No.: 19/145,430

(22) PCT Filed: Jan. 12, 2024
(86) PCT No.: PCT/EP2024/025022

§ 371 Date: Jul. 2, 2025

(30) Foreign Application Priority Data
Jan. 19, 2023 (GB) 2300768.5

(51) Int. Cl. E02F 9/08; B60L 50/60; E02F 9/18

(52) U.S. Cl. CPC E02F 9/0866; B60L 50/66; E02F 9/18

(57) ABSTRACT

An electrically powered excavator comprises a power store housing with a compartment for receiving an electrical power store and a door for closing the compartment. A power store interface is mounted within the compartment to enable easy connection of the power store during installation prior to use and during replacement in use.

### TECHNICAL FIELD

This disclosure is directed towards an electrically powered excavator with a housing for a power store, such as at least one battery and/or fuel cell. The disclose further relates to a method of assembling such an excavator.

### BACKGROUND

An electric excavator may comprise a storage battery inside the electric work machine that is charged with power using an external vehicle charging apparatus. Such batteries, particularly those for electrified excavators, are very bulky. The batteries also needing to be accessible for battery swapping, whether as part of routine maintenance or to quickly remove a depleted battery and replace it with a fully charged battery. Furthermore, batteries, hydrogen fuel cells and other such electrical power sources are commonly installed in a separate location to where the rest of an electric work machine is assembled, such as due to regulatory and safety reasons.

CN113684878A discloses an electric cylinder excavator robot. A battery compartment is provided on the side of the wheel track bracket of the chassis. A battery pack is provided in the battery compartment for supplying electricity to the machine. Such an arrangement, however, does not adequately address the aforementioned issues.

### SUMMARY

An object of the present disclosure is to provide an excavator with an improved storage solution for power stores, such as batteries or fuel cells. A further object is to provide an improved method of manufacturing excavators, particularly in the view of regulations relating to where power stores can be installed in the excavators. A yet further object is to provide an excavator with a power store storage solution with improved thermal properties and improved ease of replacement.

The present disclosure therefore provides an excavator and method in accordance with the claims.

In the excavator, the power store housing comprises a compartment for receiving the electrical power store and at least one door for closing and/or sealing the compartment. To install or replace the power store, the at least one door must be opened. As a result, the power store can be securely stored in a reinforced compartment.

The power store interface is mounted within the compartment and thus the power harness may extend from such interface, through the compartment wall and on to the electrical power system for exchanging electrical power therewith. This provides a separate connection point for the power store, improving ease of installation and replacement. The power store interface enables easy connection of the power store during installation prior to use of the excavator and during replacement whilst the excavator is in use, such as during battery swaps after depletion of charge.

Furthermore, the power store housing of the present disclosure allows for the compartment to be easily accessible and provides for the connection of the power store to the rest of the power system at or towards the end of the assembly of the excavator. In particular, in the method of the present disclosure the power store can be installed at a separate second location to the first location in which the assembly of the excavator may be substantially completed. However, by having the power store interface in the compartment, testing and debugging can be performed at the first location after assembly. This enables the manufacturing to comply with regulations relating to where power stores can be installed, whilst also enabling the delivery of the excavator without the power store to an operator separately to the power store itself.

The system is also substantially modular in that the power store housing may be substantially separate and/or thermally isolated from a hydraulic system and/or charging module on the excavator. Since the hydraulic system and/or charging module operate at a relatively high temperature, whereas the power store needs to be maintained at a relatively low temperature, such thermal isolation can improve performance of the power store.

Yet furthermore, the cooling system of the present disclosure may allow for independently controlled cooling of different power stores located in different compartments and/or chambers within such compartments. Thus the performance of the power stores may be improved.

The power stores may comprise a battery pack comprising at least one battery. These packs are convenient as they are housed in a pack housing with a handle for maintenance. Each such battery pack may be cooled separately so as to better monitor and maintain temperature for each battery.

### BRIEF DESCRIPTION OF THE DRAWINGS

By way of example only, embodiments of the present disclosure are now described with reference to, and as shown in, the accompanying drawings, in which:

FIG. 1 is a schematic perspective view of an excavator in accordance with the present disclosure;

FIG. 2 is a schematic top plan view of the excavator of FIG. 1; and

FIG. 3 is a schematic view of a power store housing of the excavator of FIG. 1.

### DETAILED DESCRIPTION

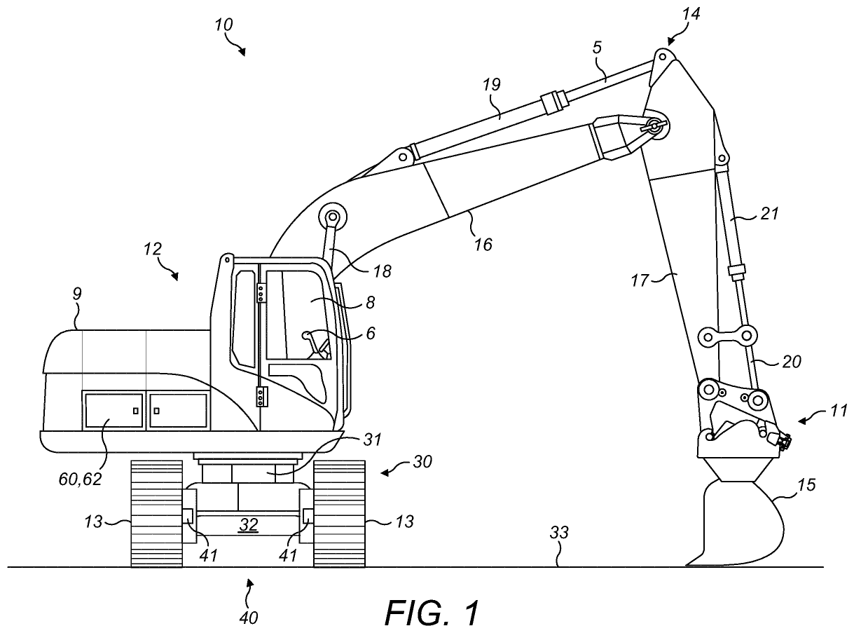

FIG. 1 illustrates an embodiment of an excavator 10, which is a work machine for excavating material from the ground, terrain and/or worksite, according to the present disclosure. The excavator 10 may comprise a main body 12 having a cab 8 for an operator and an arm arrangement 14 attached to the main body 12. The main body 12 may comprise a counterweight section 9 extending from the cab 8 on the opposite side thereof to the arm arrangement 14.

The excavator 10 may comprise a tool 15 connected to the arm arrangement 14 via a coupling arrangement 11. The arm arrangement 14 may comprise a boom 16, a stick 17 and a linkage arrangement 20 pivotally attached to one another. The coupling arrangement 11 may be mounted to the stick 17 and linkage arrangement 20. The arm arrangement 14 may comprise hydraulic actuators 18, 19, 21 for controlling the orientation and movement of the boom 16, stick 17 and linkage arrangement 20 and thereby the orientation and movement of the coupling arrangement 11 and tool 15.

The tool 15 may be of any suitable type and may, for example, be a grapple as illustrated or may be a bucket, tiltable bucket, tilt rotator, hammer, handling arm, multi-processor, pulveriser, saw, shears, blower, grinder, tiller, trencher, winch, auger, broom, cutter, planer, delimber, felling head, mulcher or rake.

The excavator 10 may comprise an undercarriage 30 to which the main body 12 is rotatably mounted, such as via a swivel joint 31. The undercarriage 30 may comprise a chassis 32 to which at least one wheel and/or track 13 may be mounted for driving the excavator 10 along a terrain 33. The swivel joint 31 may be mounted to a top of the chassis 32 and the at least one wheel and/or track 13 may be mounted to opposing sides of the chassis 32.

The excavator 10 may comprise a hydraulic system 5 for operating at least one work tool, such as tool 15 and around which fluid may be circulated. The excavator 10 may comprise a control unit for controlling the hydraulic system 5 automatically or based upon inputs received from an input device 6 controllable by an operator in the main body 12, such as a joystick or at least one button. The hydraulic system 5 may comprise a hydraulic reservoir 25, a hydraulic pump 26 and hydraulic hoses 27. The hydraulic system 5 may comprise the first, second and third hydraulic actuators 18, 19, 21 for controlling the pivoting of the arm arrangement 14 and the tool 15. The hydraulic system 5 may also comprise at least one conduit leading to or away from the at least one coupling arrangement 11 for communicating fluid to or from the at least one coupling arrangement 11 and tool 15.

The excavator 10 comprises an electrical power system 40 comprising at least one motor 41 for driving the excavator 10 across the terrain 33. The electrical power system 40 may be distributed across the excavator 10 between the main body 12 and undercarriage 30. The at least one motor 41 may be mounted in the undercarriage 30 and connected directly or indirectly to the at least one wheel and/or track 13.

The electrical power system 40 comprises an electrical power store 45, which may comprise a battery and/or fuel cell, for supplying electrical power to the electrical power system 40, in particular for driving the at least one motor 41. The electrical power system 40 may comprise a plurality of such electrical power stores 45.

The electrical power store 45 may comprise at least one battery pack 46, each battery pack 46 comprising at least one battery mounted within a pack housing 47. The at least one battery pack 46 may comprise a handle 48 mounted on the pack housing 47 for an operator to carry the at least one battery pack 46, for example when installing and removing the battery pack 46 on and from the excavator 10.

The electrical power system 40 comprises a power store interface 50 releasably connectable to the electrical power store 45 and electrically connected to the at least one motor 41 for supplying power thereto from the electrical power store 45. The electrical power system 40 may comprise a plurality of power store interfaces 50, each power store interface 50 being for connection to separate electrical power sources 45 or battery packs. The or each power store interface 50 may comprise a socket to which the electrical power store 45 can be manually releasably connected.

The power store interface 50 is connectable to a power supply external to the excavator 10 for supplying power to the electrical power system 40 by at least one external power supply cable. The cable may be releasably connected to the power store interface 45.

The electrical power system 40 comprises a charging module 55 for connection to an external charging system, particularly the external power supply, for charging the power store 45 via the power store interface 50.

The excavator 10 comprises a power store housing 60 comprising a compartment 61 for receiving the electrical power store 45. The power store housing 60 further comprises at least one door 62 for closing and/or sealing the compartment 61. The at least one door 62 is required to be opened such that the electrical power store 45 can be mounted into and/or removed from the compartment 61. The at least one door 62 may be lockable to lock the compartment 61 closed.

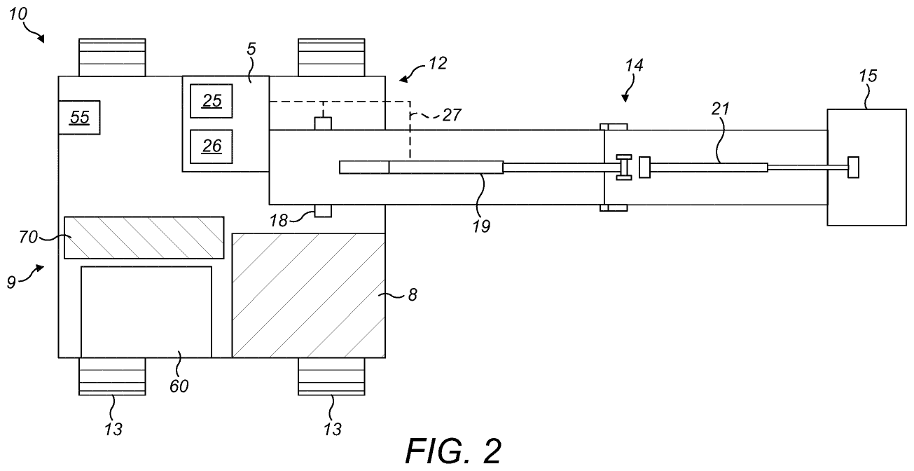

The power store housing 60 may be mounted in the main body 12 as illustrated in FIGS. 1 and 2 and may, in particular, be mounted in the counterweight section 9. The counterweight section 9 may be the portion of the main body 12 on the other side, to the arm arrangement 14, of the centre of rotation of the main body 12 relative to the undercarriage 30 about the swivel joint 31. Thus, when the power store 45 is mounted in the power store housing 60 it may act to counterbalance the weight of the arm arrangement 14 and anything being carried by the tool 15.

In an alternative embodiment the power store housing 60 may be mounted in the undercarriage 30, particularly in the chassis 32. If the excavator 10 comprises a plurality of power store housings 60, one or more housings 60 may be mounted in the main body 12 and one or more housings 60 may be mounted in the undercarriage 30.

The compartment 61 may be reinforced as the battery may comprise a large dense weight. Additionally, the compartment 61 may be sealable and fire-proof to provide for isolation of the battery/hydrogen cell in the event of a fire. In this way, the battery/hydrogen cell may be isolated from the rest of the machine 10 in the event of fire. In some embodiments, the power store housing 60 may be sealable and fire-proof to isolate the battery/fuel cell within the power store housing 60. Additionally, the power store housing 60 may be transported, stored and/or the like in a sealed mode when the power store housing 60 is not deployed on a work machine 10.

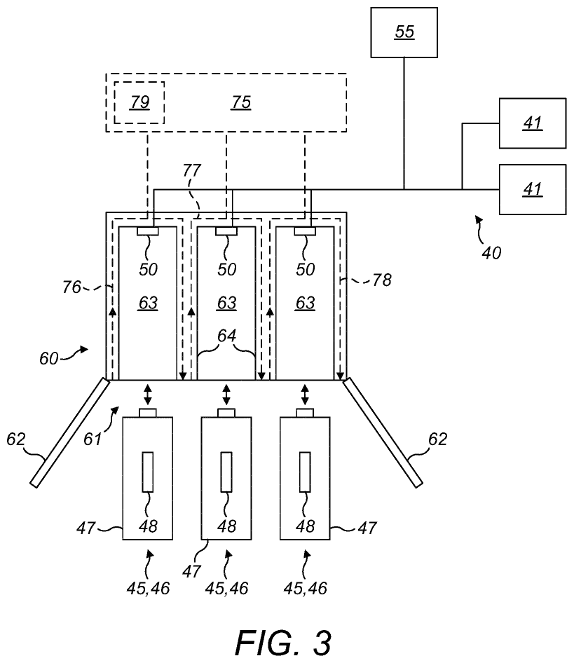

The compartment 61 may comprise a single chamber 63 or may, alternatively and as shown in FIG. 3, comprise or contain a plurality of adjacent chambers 63 separated by chamber separators 64. The or each chamber 63 may be configured to receive one or a plurality of power store(s) 45, such as a single battery pack 46 per chamber 63. A single door 61 may cover all adjacent chambers 63 or, as illustrated, a plurality of doors 61 may cover the chambers 63. The power store(s) 45 may be mounted so as to be in contact with at least part of the walls of the chamber 63.

The or each power store interface 50 is mounted within the compartment 61 and the or each power store interface 50 may be mounted within the or each chamber 50. The power store 45 may be connected to the power store interface 50 during installation. The power store interface 50 may only be accessible when the at least one door 62 is open. When the at least one external power supply cable is connected to the or each power store interface 50, the cable may extend through the chamber 63, out of the compartment 61, past the at least one door 62 and to the external power supply.

The charging module 55 and/or hydraulic system 5, particularly the reservoir 25, pump 26 and/or hoses 27 thereof, may be located separately to the compartment 61 such that the charging module 55 and/or hydraulic system 5 are substantially thermally isolated from the compartment 61. In particular, the charging module 55 and/or hydraulic system 5 may be at least about 0.25 m, at least about 0.5 m and/or at least about 0.75 m from the compartment 61. The charging module 55 and/or hydraulic system 5 may be located on an opposing side of the excavator 10 to the compartment 61, for example by not forming part of the counterweight 9 and/or being in the undercarriage 32.

The excavator 10 may comprise a thermal insulation structure 70 at least partially around and adjacent to, and potentially at least partially defining, the compartment 61 and/or each chamber 63. The thermal insulation structure 70 may substantially thermally insulate the compartment 61 from other components of the excavator 10, particularly the hydraulic system 5 and the charging module 55. In particular, the thermal insulation structure 70 may insulate the compartment 61 and the power store(s) 45 therein from the higher operating temperatures of the hydraulic system 5 and charging module 55.

The thermal insulation structure 70 may comprise insulating material, such as blankets, filler or the like, specifically located for thermal insulation between the hydraulic system 5 and/or charging module 55 and the compartment 61. The insulating material may have the sole purpose of insulation, rather than forming a supporting structure or the like in the excavator 10.

The excavator 10 may further comprise a cooling system 75 for cooling the power store(s) 45 when mounted in the compartment 61. The cooling system 75 may comprise at least one cooling circuit 76, 77, 78 extending around each power store 45, compartment 61 and/or chamber 63. The cooling system 75 may comprise or be connected to a controller 79 and the controller 79 may control the cooling system 75 so as to independently cool each power store 45.

The or each cooling circuit 76, 77, 78 may extend around the compartment 61 and/or chamber 63 and may extend through the or each chamber separator 64. In particular, the or each cooling circuit 76, 77, 78 may extend directly adjacent to or along the walls of each chamber 63 so as to be substantially adjacent to each power store 45. The cooling system 75 may be configured to circulate coolant around each cooling circuit 76, 77, 78 independently and with a heat exchanger.

Although not illustrated, the or each cooling circuit 76, 77, 78 may extend at least partially through the or each battery pack 46, such as through the pack housing 47. When a battery pack 46 is inserted into the compartment 61, the battery pack 46 may be connected to the cooling system 75 such that the cooling system 75 can circulate coolant around the battery pack 46, such as the pack housing 47.

### INDUSTRIAL APPLICABILITY

The excavator 10 of the present disclosure can beneficially be assembled and tested in one location before the power store 45 is installed in a second, different, location. In particular, for regulatory or practical reasons the power store 45 may not be able to be installed in the same manufacturing location as the power store 45.

The present disclosure therefore provides a method of manufacturing an excavator 10 comprising at the first location, at least partially assembling the excavator 10. The assembly at the first location may be assembly up to the excavator 10 being ready to receive the power store 45. The excavator 10 may have been partially assembled elsewhere before the first location and assembly of the excavator 10, such as completion of the arm arrangement 14, may take place at the second or a subsequent location.

At the first location the electrical power system 40 is at least partially assembled and the power store housing 60 is at least partially assembled. At the first location, the undercarriage 30, main body 12, arm arrangement 14, hydraulic system 5, charging module 55, thermal insulation structure and/or cooling system 75 may also be at least partially assembled. In particular, the power system 40 and power store housing 60 may be prepared or assembled such that they are ready for the power store 45 to be inserted into the compartment 61 for supplying power to the power system 40.

At the first location the at least partially assembled excavator 10 may be tested, such as by the at least one motor 41 being operated in a test environment, by connecting the power store interface 50 to the external power supply, such as via the cable extending through the compartment 61 therebetween. Debugging of the power system 40 may also take place at the first location.

After the assembly at the first location, the at least partially assembled excavator 10 is moved to a second location.

The first and second locations may each be different manufacturing sites or may both be separate sections of the same manufacturing sites. The first and second locations may be in different buildings, different grounds and/or separated by at least 100 m or at least 1 km. The first location may be the manufacturer's property whilst the second location may be the property of the operator, with the operator taking delivery of the power store 45 at their property separately to delivery of the assembled excavator 10. The second location may be defined as a place considered suitable for the installation of the power store 45 under the applicable manufacturing regulations. The first location may be defined as a place considered unsuitable for the installation of the power store 45 under the applicable manufacturing regulations.

At the second location, the at least one door 62 may be opened, the power store 45 may be installed in the compartment 61 and the power store 45 may connected to the power store interface 50. If applicable, the cooling system 75 may be connected to any cooling circuit 76, 77, 78 forming part of the power store 45 or at least one battery pack 46. The at least one door 61 may then be shut. If there are multiple power stores 45, they may be inserted into the chambers 63 in the compartment 61 and/or may be inserted into each of the plurality of compartments 61.

The power store 45 may be operable to supply power to the power system 40 at the second location. The excavator 10 may then be operated at the second location, such as to perform work, or may be moved onto a further location to perform work.

In use, the compartment 61 and power store 45 are substantially thermally insulated and separated from the hydraulic system 5 and/or charging module 55 by the separation therebetween and/or the thermal insulation structure 70. Therefore, the high temperatures of the hydraulic system 5 and/or charging module 55 may not impact the operation of the power store 45.

In use, the cooling system 75 may also be operated to maintain the power store 45 at a predetermined operating temperature or within a predetermined operating temperature range. In the case of there being multiple power stores 45, each cooling circuit 76, 77, 78 extending at least partially around each power store 45 may be operated independently so as to maintain each power store 45 at its own predetermined operating temperature or predetermined operating temperature range.

Furthermore, if the power store 45 is depleted, it may be charged in the excavator 10 via the charging module 55. Alternatively, at the site of use of the excavator 10 (e.g. on a worksite) the depleted power store 45 may be removed from the compartment 61 and replaced with a charged power store 45. Such power store 45 replacement may enable the excavator 10 to operate for longer on the worksite.

1. An excavator comprising:
an electrical power system comprising:
at least one motor for driving the excavator across a terrain;
an electrical power store; and
a power store interface releasably connectable to the electrical power store and electrically connected to the at least one motor for supplying power thereto;
a power store housing comprising:
a compartment for receiving the electrical power store; and
at least one door for closing and/or sealing the compartment, wherein the at least one door is required to be opened such that the electrical power store can be mounted into and/or removed from the compartment,
wherein the power store interface is mounted within the compartment.

2. An excavator according to claim 1 wherein the power store comprises at least one battery pack comprising at least one battery, the at least one battery pack being mountable within the compartment.

3. An excavator according to claim 1 or further comprising a thermal insulation structure at least partially around and adjacent to the compartment or within the compartment.

4. An excavator according to claim 1 wherein the electrical power system comprises a charging module for connection to an external charging system for charging the power store when mounted within the compartment via the power store interface, wherein the charging module is located separately to the compartment such that the charging module is substantially thermally isolated from the compartment.

5. An excavator according to claim 1 wherein the electric work machine comprises at least one work tool and a hydraulic system for operating the at least one work tool, wherein the hydraulic system is located separately to the compartment so as to be substantially thermally isolated from the compartment.

6. An excavator according to claim 1 wherein the power store interface is connectable to a power supply external to the electric work machine for supplying power to the electrical power system by at least one external power supply cable releasably connected to the power store interface, extending through and out of the compartment to the external power supply.

7. An excavator according to claim 1 wherein the power store storage system comprises:
at least one further compartment for receiving at least one further power store; and
at least one further power store interface to which the at least one further power store is releasably connectable, the at least one further power store interface being mounted within the compartment and being electrically connected to the electrical power system for suppling power thereto from the at least one further power store.

8. An excavator according to claim 1 wherein the compartment comprises a plurality of chambers separated by at least one chamber separator, each chamber being configured to receive a power store and being closable by the at least one door.

9. An excavator according to claim 1 comprising a cooling system for cooling the power store when mounted in the compartment, the cooling system comprising at least one cooling circuit extending around the power store.

10. An excavator according to claim 1 wherein at least one cooling circuit extends through the at least one chamber separator.

11. An excavator as claimed in claim 1 comprising a main body rotatably mounted to an undercarriage, wherein the power store is located in the undercarriage or in a counterweight section of the main body.

12. A method of manufacturing an excavator comprising:
at a first location, at least partially assembling the excavator comprising:
assembling an electrical power system comprising:
at least one motor for driving the excavator across a terrain;
an electrical power store; and
a power store interface releasably connectable to the electrical power store and electrically connected to the at least one motor for supplying power thereto;
assembling a power store housing comprising:
a compartment for receiving the electrical power store; and
at least one door for closing and/or sealing the compartment, wherein the at least one door is required to be opened such that the electrical power store can be mounted into and/or removed from the compartment,
wherein the power store interface is mounted within the compartment.

13. A method as claimed in claim 12 wherein:
at the first location the at least partially assembled excavator is tested by connecting the power store interface to an external power supply; and/or
after the assembly at the first location, the at least partially assembled excavator is moved to a second location, and at the second location, the at least one door is opened, the power store is installed in the compartment and the power store is connected to the power store interface.
